(19) United States
(12) Patent Application Publication
(10) Pub. No.: US 2026/0002549 A1
(43) Pub. Date: Jan. 1, 2026

(54) HYDRAULICALLY POWERED POWER SYSTEMS AND HYDRAULIC CIRCUITS HAVING A FLOW VALVE AND A HYDRAULIC PROPORTIONAL BYPASS VALVE

(71) Applicant: Illinois Tool Works Inc., Glenview, IL (US)

(72) Inventors: David Radtke, Appleton, WI (US); Adam Smith, Appleton, WI (US); Grayson Vandenbush, Appleton, WI (US); Tim Karpf, Appleton, WI (US); Aditya Vhanesa, Appleton, WI (US)

(21) Appl. No.: 19/252,620

(22) Filed: Jun. 27, 2025

Related U.S. Application Data
(60) Provisional application No. 63/665,880, filed on Jun. 28, 2024.

(51) Int. Cl. F15B 13/04; F15B 19/00; H02K 7/18

(52) U.S. Cl. CPC F15B 13/0401; F15B 19/00; H02K 7/1823; F15B 2211/45

(57) ABSTRACT

A power system comprises: a motor; a flow valve; and a bypass valve; a generator configured to convert mechanical power from the motor to electrical current; a sensor configured to measure an operating frequency of the electrical current, and generate a sensor signal comprising a measured operating frequency; and control circuitry configured to: when the generator is in an operating mode, output a first control signal to control the flow valve to enable the flow of the hydraulic fluid to the motor and output a second control signal to control a degree of openness of the bypass valve based on the sensor signal, and when the generator is in an off mode, output the first control signal to control the flow valve to disable the flow of the hydraulic fluid to the motor.

### RELATED APPLICATIONS

The present application claims the benefit of U.S. Provisional Patent Application Ser. No. 63/665,880, filed Jun. 28, 2024, entitled “HYDRAULICALLY POWERED POWER SYSTEMS AND HYDRAULIC CIRCUITS HAVING A FLOW VALVE AND A HYDRAULIC PROPORTIONAL BYPASS VALVE.” The entirety of U.S. Provisional Patent Application Ser. No. 63/665,880 is expressly incorporated herein by reference.

### FIELD OF THE DISCLOSURE

This disclosure relates generally to hydraulic circuits and, more particularly, to hydraulically powered power systems comprising hydraulic circuits.

### BACKGROUND

Hydraulically powered power systems use hydraulic fluid to generate power. For example, a hydraulically powered power system may include a pump which pumps hydraulic fluid through a hydraulic circuit comprising a hydraulically powered device. For example, the pump may power a hydraulically driven motor, thereby actuating the motor to generate and output mechanical power, e.g., to power a generator.

### SUMMARY

Hydraulic circuits and hydraulically powered power systems having a flow valve and a hydraulic proportional bypass valve are disclosed, substantially as illustrated by and described in connection with at least one of the figures, as set forth more completely in the claims.

### BRIEF DESCRIPTION OF THE DRAWINGS

FIGS. 1A and 1B illustrate example hydraulically powered power systems, in accordance with aspects of this disclosure;

FIG. 2 illustrates an example hydraulic circuit comprising a flow valve and a hydraulic proportional bypass valve, in accordance with aspects of this disclosure;

FIG. 3 illustrates a block diagram of example control circuitry for operating the systems of FIGS. 1A, 1B, and/or 2, in accordance with aspects of this disclosure; and

FIG. 4 illustrates a flowchart representative of example machine readable instructions which may be executed by the example control circuitry of FIG. 3 to control the systems of FIGS. 1A, 1B, and/or 2, in accordance with aspects of this disclosure.

The figures are not necessarily to scale. Where appropriate, similar or identical reference numbers are used to refer to similar or identical components.

### DETAILED DESCRIPTION

Disclosed example methods, systems, and hydraulic circuits involve adjusting an amount of hydraulic fluid provided to a hydraulically driven motor using a flow valve and a hydraulic proportional bypass valve.

A disclosed example hydraulically powered power system includes a flow valve, which enables or disables flow of hydraulic fluid to a hydraulically driven motor, which converts hydraulic power to mechanical power, and a hydraulic proportional bypass valve, which diverts a controllable portion of the hydraulic fluid from the hydraulically driven motor and to a fluid return based on a degree of openness of the hydraulic proportional bypass valve. Accordingly, based on the degree of openness of the hydraulic proportional bypass valve, more or less hydraulic fluid flows to the hydraulically driven motor and, by changing the flow of hydraulic fluid to the hydraulically driven motor, the mechanical power output of the hydraulically driven motor may also be changed. The hydraulically driven motor provides the mechanical power to a generator, thereby powering the generator to generate electrical power as, e.g., an alternating electrical current (“AC power”). The hydraulically powered power system may also include one or more auxiliary devices (e.g., lighting, a welding system and/or components thereof (e.g., a welding wire feeder and/or a welding torch), an air compressor, a charging system (e.g., a battery charging system), a hydraulic pump, a tool, a crane, a grinder, a wrench, etc.). The auxiliary device(s) may be powered by any, some, or all of hydraulic power (e.g., from the hydraulic circuit), mechanical power (e.g., from the hydraulically driven motor), and/or electrical power (e.g., from the electrical current generated by the generator).

Since the degree of openness of the hydraulic proportional bypass valve can control an operating speed (i.e., a rotational speed) of the hydraulically driven motor and/or a torque generated by the hydraulically driven motor, the degree of openness of the hydraulic proportional bypass valve can also control an operating frequency of electrical power (e.g., an alternating electrical current) output by the generator and/or an operating speed (measured in, e.g., revolutions per minute (“RPM”)) of the generator. The flow valve and/or the hydraulic proportional bypass valve can be controlled based on a measured operating frequency of electrical power (e.g., an electrical current) output by the generator, a measured operating speed (measured in, e.g., RPM) of the generator, and/or a measured operating speed (measured in, e.g., RPM) of the hydraulically driven motor. Accordingly, the hydraulic proportional bypass valve may be used to control an operating frequency of electrical power (e.g., an electrical current) output by the generator, an operating speed of the generator, and/or an operating speed of the hydraulically driven motor by controlling the degree of openness of the hydraulic proportional bypass valve. For example, the degree of openness of the hydraulic proportional bypass valve may be controlled to bring the measured operating frequency, the measured operating speed of the generator, and/or the measured operating speed of the hydraulically driven motor within a tolerance threshold of a target operating frequency and/or a target operating speed. Further, the flow valve and/or the hydraulic proportional bypass valve may be additionally or alternatively controlled based on a load demand of one or more auxiliary devices. Accordingly, the hydraulic proportional bypass valve may be used to control an amount of hydraulic power, mechanical power, and/or electrical power provided to the auxiliary device(s) by the hydraulically powered power system. For example, the degree of openness of the hydraulic proportional bypass valve may be controlled to bring the hydraulic power, mechanical power, and/or electrical power provided to the auxiliary device(s) to, substantially to, and/or closer to the load demand of the auxiliary load.

Conventional hydraulically powered power systems and hydraulic circuits provide little control over output levels of hydraulically powered systems or devices. Disclosed example methods, systems, and hydraulic circuits enable a hydraulic power, mechanical power, and/or electrical power generated by a hydraulically powered power system to be controlled by controlling a flow valve and/or a degree of openness of a hydraulic proportional bypass valve based on one or more sensor signals. For example, controlling a flow valve and/or a degree of openness of a hydraulic proportional bypass valve enables controlling of any, some, or all of a measured operating frequency of electrical power output by a generator of and/or powered by the hydraulically powered power system, a measured operating speed of the generator of and/or powered by the hydraulically powered power system, a measured operating speed of a hydraulically driven motor of and/or powered by the hydraulically powered power system, and/or an auxiliary load output provided to one or more components of and/or devices powered by the hydraulically powered power system.

Disclosed examples thereby enable a hydraulically powered power system to generate power more accurately by adjusting a magnitude of the generated power based on feedback signals. In some such examples, the feedback signals comprise any, some, or all of a measured operating frequency of electrical power output by a generator of the hydraulically powered power system, a measured operating speed of the generator of the hydraulically powered power system, a measured operating speed of a hydraulically driven motor of the hydraulically powered power system, a load demand exerted by one or more components and/or devices upon the hydraulically powered power system, a desired load demand of one or more components and/or devices to exert upon the hydraulically powered power system, and/or a load output provided to one or more components of and/or devices powered by the hydraulically powered power system. Disclosed examples also increase a quality of power generated by the hydraulically powered power system, e.g., by more closely matching a power generated by the hydraulically powered power system to a desired power magnitude. In some such examples, the desired power magnitude is determined by any, some, or all of a target operating frequency of electrical power output by a generator of the hydraulically powered power system, a target operating speed of the generator of the hydraulically powered power system, a target operating speed of a hydraulically driven motor of the hydraulically powered power system, a (desired or actual) load demand of one or more components and/or devices exerting a load upon the hydraulically powered power system, and/or a target load output provided to one or more components of and/or devices powered by the hydraulically powered power system.

Further, disclosed examples also improve the efficiency of a hydraulically powered power system, e.g., by increasing a quality of power generated by the hydraulically powered power system. For example, a generator powered by a hydraulically driven motor may operate more efficiently when an operating frequency of electrical power output by the generator is closer in magnitude to a target operating frequency (e.g., 60 Hz), and so controlling a degree of openness of a hydraulic proportional bypass valve to bring the operating speed closer to the target operating speed may improve efficiency of the hydraulically powered power system. Further still, disclosed examples reduce an amount of input power required to power the hydraulically powered power system. For example, increasing a degree of openness of the hydraulic proportional bypass valve (e.g., to increase accuracy, quality, and/or efficiency of power generated by the hydraulically powered power system) may decrease an amount of power required to operate a hydraulic pump of the hydraulically powered power system, thereby decreasing a power consumption of the hydraulically powered power system.

Disclosed examples also enable the automated control of power generated by a hydraulically powered power system. Accordingly, disclosed examples may also improve safety of a user of the hydraulically powered power system, by reducing and/or eliminating a need of the user to manually adjust the hydraulically powered power system to control modify power generated by the hydraulically powered power system.

As utilized herein the terms “circuits,” “circuitry,” and “control circuitry” refer to physical electronic components (i.e. hardware) and any software and/or firmware (“code”) which may configure the hardware, be executed by the hardware, and or otherwise be associated with the hardware. As used herein, for example, a “circuit” may comprise any analog and/or digital components, power and/or control elements (such as a microprocessor, digital signal processor (DSP), software, and the like), discrete and/or integrated components, associated software, hardware, and/or firmware, and/or portions and/or combinations thereof. As used herein, for example, a particular processor and memory storage device may comprise a first “circuit” when executing a first set of one or more lines of code and may comprise a second “circuit” when executing a second set of one or more lines of code. As utilized herein, circuitry is “operable” to, “configurable to,” and/or “configured to” perform a function whenever the circuitry comprises the necessary hardware and code (if any is necessary) to perform the function, regardless of whether performance of the function is disabled or not enabled (for example, by an operator-configurable setting, factory trim, etc.).

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general-purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory storage device.

As used, herein, the term “memory,” “memory storage device,” and/or “memory device” means computer hardware or circuitry to store information for use by a processor and/or other digital device. The memory, memory storage device, and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory, memory storage device, and/or memory device can be configured to store code, instructions, applications, software, firmware and/or data, and may be external, internal, or both with respect to a processor.

Features described herein make reference to the accompanying drawings in which exemplary embodiments of the disclosure are shown. Whenever possible, the same reference numerals are used throughout the drawings to refer to the same or like parts. However, it should be understood that the systems of this disclosure can be embodied in many different forms and should not be construed as limited to the embodiments set forth herein.

The term “power” is used throughout this specification, for convenience, to describe hydraulic, mechanical, and electrical power. However, the term “power,” as used herein, also includes related measures such as energy, current, voltage, resistance, conductance, and enthalpy. For example, controlling “power” may involve controlling voltage, current, energy, resistance, conductance, and/or enthalpy, and/or controlling based on “power” may involve controlling based on voltage, current, energy, resistance, conductance, and/or enthalpy.

It is to be understood that, as used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the word “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage, or mode of operation.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.” and “for example” set off lists of one or more non-limiting examples, instances, or illustrations. While various features, elements or steps of particular embodiments can be disclosed using the transitional phrase “comprising,” it is to be understood that alternative embodiments, including those that can be described using the transitional phrases “consisting of” or “consisting essentially of,” are implied. Thus, for example, implied alternative embodiments to an apparatus that comprises A+B+C include embodiments where an apparatus consists of A+B+C and embodiments where an apparatus consists essentially of A+B+C.

Disclosed example hydraulically powered power systems comprise: a hydraulic circuit comprising: a hydraulically driven motor configured to convert hydraulic power to mechanical power, a flow valve configured to enable or disable flow of hydraulic fluid to the hydraulically driven motor, and a hydraulic proportional bypass valve configured to divert a portion of the hydraulic fluid from an inlet to the hydraulically driven motor to a fluid return based on a degree of openness of the hydraulic proportional bypass valve; a generator configured to convert the mechanical power from the hydraulically driven motor to electrical power having an operating frequency; a first sensor configured to measure the operating frequency of the electrical power and generate a first sensor signal comprising a measured operating frequency; and control circuitry configured to: determine whether the generator is in an operating mode or an off mode; when the generator is in the operating mode, output a first control signal to control the flow valve to direct the flow of the hydraulic fluid to the hydraulically driven motor and output a second control signal to control the degree of openness of the hydraulic proportional bypass valve based on the measured operating frequency, and when the generator is in the off mode, output the first control signal to control the flow valve to direct the flow of the hydraulic fluid to the fluid return.

In some example hydraulically powered power systems, the control circuitry is further configured to: control the hydraulic proportional bypass valve to divert more fluid to decrease the operating frequency; and control the hydraulic proportional bypass valve to divert less fluid to increase the operating frequency.

In some example hydraulically powered power systems, the controlling of the degree of openness of the hydraulic proportional bypass valve is based on comparing the measured operating frequency to a target operating frequency. In some such example hydraulically powered power systems, controlling of the degree of openness of the hydraulic proportional bypass valve is further based on a tolerance threshold of the target operating frequency. In some such example hydraulically powered power systems, the tolerance threshold is less than or equal to 6% of the target operating frequency and greater than or equal to 2% of the target operating frequency.

In some example hydraulically powered power systems, controlling of the degree of openness of the hydraulic proportional bypass valve is based on comparing the measured operating frequency to a target operating frequency and a tolerance threshold of the target operating frequency, wherein the hydraulically powered power system further comprises a user interface electrically coupled to the control circuitry and configured to receive the tolerance threshold and generate an input signal comprising the tolerance threshold.

In some example hydraulically powered power systems, controlling of the degree of openness of the hydraulic proportional bypass valve is based on comparing the measured operating frequency to a target operating frequency, wherein the hydraulically powered power system further comprises a user interface electrically coupled to the control circuitry and configured to receive the target operating frequency and generate an input signal comprising the target operating frequency.

In some example hydraulically powered power systems, controlling of the degree of openness of the hydraulic proportional bypass valve is based on comparing the first sensor signal to an input signal representative of a target operating frequency, wherein the target operating frequency is less than or equal to 65 hertz and greater than or equal to 35 hertz.

In some example hydraulically powered power systems, wherein the hydraulically powered power system further comprises further comprising an auxiliary device and a second sensor configured to measure a load demand of the auxiliary device and generate a second sensor signal comprising a measured load demand, wherein the controlling of the degree of openness of the hydraulic proportional bypass valve is further based on the measured load demand. In some such example hydraulically powered power systems, the controlling of the degree of openness of the hydraulic proportional bypass valve is further based on comparing the measured load demand to a threshold load value. In some such example hydraulically powered power systems, the hydraulically powered power system further comprises a user interface electrically coupled to the control circuitry and configured to receive the threshold load value and generate an input signal comprising the threshold load value.

In some example hydraulically powered power systems, the control circuitry is further configured to control an operating speed of the hydraulically driven motor by controlling a flow rate of the hydraulic fluid at the inlet to the hydraulically driven motor. In some such example hydraulically powered power systems, the control circuitry is further configured to: determine a measured operating speed of the hydraulically driven motor based on the measured operating frequency; and when the generator is in the operating mode, output the second control signal to control the degree of openness of the hydraulic proportional bypass valve based on the measured operating speed. In some such example hydraulically powered power systems, the controlling of the operating speed of the hydraulically driven motor is further based on comparing the measured operating speed to a target operating speed. In some such example hydraulically powered power systems, the controlling of the degree of openness of the hydraulic proportional bypass valve is further based on a tolerance threshold of the target operating speed. In some such example hydraulically powered power systems, the tolerance threshold is less than or equal to 6% of the target operating speed and greater than or equal to 2% of the target operating speed.

In some example hydraulically powered power systems, the control circuitry is further configured to: control an operating speed of the hydraulically driven motor by controlling a flow rate of the hydraulic fluid at the inlet to the hydraulically driven motor; determine a measured operating speed of the hydraulically driven motor based on the measured operating frequency; and, when the generator is in the operating mode, output the second control signal to control the degree of openness of the hydraulic proportional bypass valve based on comparing the measured operating speed to a target operating speed and a tolerance threshold of the target operating speed, wherein the hydraulically powered power system further comprises a user interface electrically coupled to the control circuitry and configured to receive the tolerance threshold and generate an input signal comprising the tolerance threshold.

In some example hydraulically powered power systems, the control circuitry is further configured to: control an operating speed of the hydraulically driven motor by controlling a flow rate of the hydraulic fluid at the inlet to the hydraulically driven motor; determine a measured operating speed of the hydraulically driven motor based on the measured operating frequency; and, when the generator is in the operating mode, output the second control signal to control the degree of openness of the hydraulic proportional bypass valve based on comparing the measured operating speed to a target operating speed, wherein the hydraulically powered power system further comprises a user interface electrically coupled to the control circuitry and configured to receive the target operating speed and generate an input signal comprising the target operating speed.

In some example hydraulically powered power systems, the hydraulically powered power system further comprises a second sensor configured to measure the operating speed of the hydraulically driven motor and generate a second sensor signal comprising a measured operating speed of the hydraulically driven motor, wherein the control circuitry is further configured to: control the operating speed of the hydraulically driven motor by controlling a flow rate of the hydraulic fluid at the inlet to the hydraulically driven motor; and when the generator is in the operating mode, output the second control signal to control the degree of openness of the hydraulic proportional bypass valve based on the measured operating speed of the hydraulically driven motor.

In some example hydraulically powered power systems, the operating mode comprises an active mode, wherein the control circuitry is further configured to: when the generator is in the operating mode, determine whether the generator is in the active mode; and when the generator is in the active mode, control the degree of openness of the hydraulic proportional bypass valve based on comparing the measured operating frequency to a target operating frequency, wherein the target operating frequency is less than or equal to 65 hertz and greater than or equal to 45 hertz.

In some example hydraulically powered power systems, the operating mode comprises a standby mode, wherein the control circuitry is further configured to: when the generator is in the operating mode, determine whether the generator is in the standby mode; and when the generator is in the standby mode, control the degree of openness of the hydraulic proportional bypass valve based on comparing the measured operating frequency to a target operating frequency, wherein the target operating frequency is less than or equal to 45 hertz and greater than or equal to 35 hertz.

In some example hydraulically powered power systems, the hydraulic proportional bypass valve comprises a solenoid; and the control circuitry is further configured to control the hydraulic proportional bypass valve by controlling the solenoid to adjust the degree of openness.

Disclosed example hydraulically powered power systems comprise: a hydraulic circuit comprising: a hydraulically driven motor configured to convert hydraulic power to mechanical power, a flow valve configured to enable or disable flow of hydraulic fluid to the hydraulically driven motor, and a hydraulic proportional bypass valve configured to divert a portion of the hydraulic fluid from an inlet to the hydraulically driven motor to a fluid return based on a degree of openness of the hydraulic proportional bypass valve; a generator configured to convert the mechanical power from the hydraulically driven motor to electrical power; a first sensor configured to measure a first operating speed of the generator and generate a first sensor signal comprising a first measured operating speed of the generator; and control circuitry configured to: determine whether the generator is in an operating mode or an off mode; when the generator is in the operating mode, output a first control signal to control the flow valve to direct the flow of the hydraulic fluid to the hydraulically driven motor and output a second control signal to control the degree of openness of the hydraulic proportional bypass valve based on the first measured operating speed of the generator, and when the generator is in the off mode, output the first control signal to control the flow valve to direct the flow of the hydraulic fluid to the fluid return.

In some example hydraulically powered power systems, the control circuitry is further configured to: control the hydraulic proportional bypass valve to divert more fluid to decrease the first operating speed; and control the hydraulic proportional bypass valve to divert less fluid to increase the first operating speed.

In some example hydraulically powered power systems, the controlling of the degree of openness of the hydraulic proportional bypass valve is based on comparing the first measured operating speed to a target operating speed. In some such example hydraulically powered power systems, controlling of the degree of openness of the hydraulic proportional bypass valve is further based on a tolerance threshold of the target operating speed. In some such example hydraulically powered power systems, the tolerance threshold is less than or equal to 6% of the target operating speed and greater than or equal to 2% of the target operating speed.

In some example hydraulically powered power systems, controlling of the degree of openness of the hydraulic proportional bypass valve is based on comparing the first measured operating speed to a target operating speed and a tolerance threshold of the target operating speed, wherein the hydraulically powered power system further comprises a user interface electrically coupled to the control circuitry and configured to receive the tolerance threshold and generate an input signal comprising the tolerance threshold.

In some example hydraulically powered power systems, controlling of the degree of openness of the hydraulic proportional bypass valve is based on comparing the first measured operating speed to a target operating speed, wherein the hydraulically powered power system further comprises a user interface electrically coupled to the control circuitry and configured to receive the target operating speed and generate an input signal comprising the target operating speed.

In some example hydraulically powered power systems, wherein the hydraulically powered power system further comprises further comprising an auxiliary device and a second sensor configured to measure a load demand of the auxiliary device and generate a second sensor signal comprising a measured load demand, wherein the controlling of the degree of openness of the hydraulic proportional bypass valve is further based on the measured load demand. In some such example hydraulically powered power systems, the controlling of the degree of openness of the hydraulic proportional bypass valve is further based on comparing the measured load demand to a threshold load value. In some such example hydraulically powered power systems, the hydraulically powered power system further comprises a user interface electrically coupled to the control circuitry and configured to receive the threshold load value and generate an input signal comprising the threshold load value.

In some example hydraulically powered power systems, the control circuitry is further configured to control a second operating speed of the hydraulically driven motor by controlling a flow rate of the hydraulic fluid at the inlet to the hydraulically driven motor. In some such example hydraulically powered power systems, the control circuitry is further configured to: determine a second measured operating speed of the hydraulically driven motor based on the first measured operating speed; and when the generator is in the operating mode, output the second control signal to control the degree of openness of the hydraulic proportional bypass valve based on the second measured operating speed. In some such example hydraulically powered power systems, the controlling of the second operating speed of the hydraulically driven motor is further based on comparing the second measured operating speed to a target operating speed. In some such example hydraulically powered power systems, the controlling of the degree of openness of the hydraulic proportional bypass valve is further based on a tolerance threshold of the target operating speed. In some such example hydraulically powered power systems, the tolerance threshold is less than or equal to 6% of the target operating speed and greater than or equal to 2% of the target operating speed.

In some example hydraulically powered power systems, the control circuitry is further configured to: control a second operating speed of the hydraulically driven motor by controlling a flow rate of the hydraulic fluid at the inlet to the hydraulically driven motor; determine a second measured operating speed of the hydraulically driven motor based on the first measured operating speed; and, when the generator is in the operating mode, output the second control signal to control the degree of openness of the hydraulic proportional bypass valve based on comparing the second measured operating speed to a target operating speed and a tolerance threshold of the target operating speed, wherein the hydraulically powered power system further comprises a user interface electrically coupled to the control circuitry and configured to receive the tolerance threshold and generate an input signal comprising the tolerance threshold.

In some example hydraulically powered power systems, the control circuitry is further configured to: control a second operating speed of the hydraulically driven motor by controlling a flow rate of the hydraulic fluid at the inlet to the hydraulically driven motor; determine a second measured operating speed of the hydraulically driven motor based on the first measured operating speed; and, when the generator is in the operating mode, output the second control signal to control the degree of openness of the hydraulic proportional bypass valve based on comparing the second measured operating speed to a target operating speed, wherein the hydraulically powered power system further comprises a user interface electrically coupled to the control circuitry and configured to receive the target operating speed and generate an input signal comprising the target operating speed.

In some example hydraulically powered power systems, the hydraulically powered power system further comprises a second sensor configured to measure the second operating speed of the hydraulically driven motor and generate a second sensor signal comprising a second measured operating speed of the hydraulically driven motor, wherein the control circuitry is further configured to: control the second operating speed of the hydraulically driven motor by controlling a flow rate of the hydraulic fluid at the inlet to the hydraulically driven motor; and when the generator is in the operating mode, output the second control signal to control the degree of openness of the hydraulic proportional bypass valve based on the second measured operating speed of the hydraulically driven motor.

In some example hydraulically powered power systems, the operating mode comprises an active mode, wherein the control circuitry is further configured to: when the generator is in the operating mode, determine whether the generator is in the active mode; and when the generator is in the active mode, control the degree of openness of the hydraulic proportional bypass valve based on comparing the first measured operating speed to a target operating frequency, wherein the target operating frequency is less than or equal to 65 hertz and greater than or equal to 45 hertz.

In some example hydraulically powered power systems, the operating mode comprises a standby mode, wherein the control circuitry is further configured to: when the generator is in the operating mode, determine whether the generator is in the standby mode; and when the generator is in the standby mode, control the degree of openness of the hydraulic proportional bypass valve based on comparing the first measured operating speed to a target operating speed, wherein the target operating frequency is less than or equal to 45 hertz and greater than or equal to 35 hertz.

In some example hydraulically powered power systems, the hydraulic proportional bypass valve comprises a solenoid; and the control circuitry is further configured to control the hydraulic proportional bypass valve by controlling the solenoid to adjust the degree of openness.

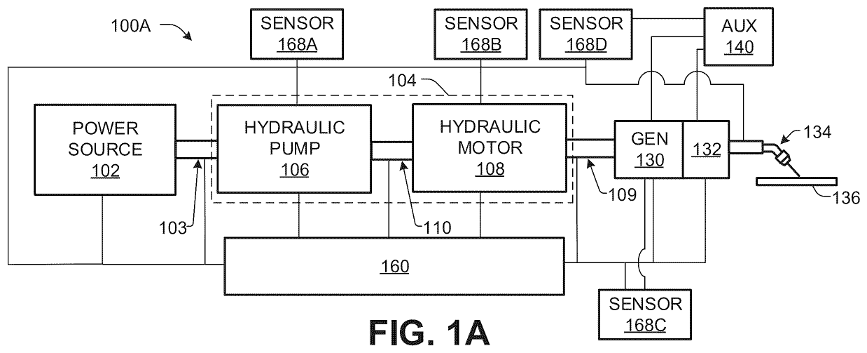

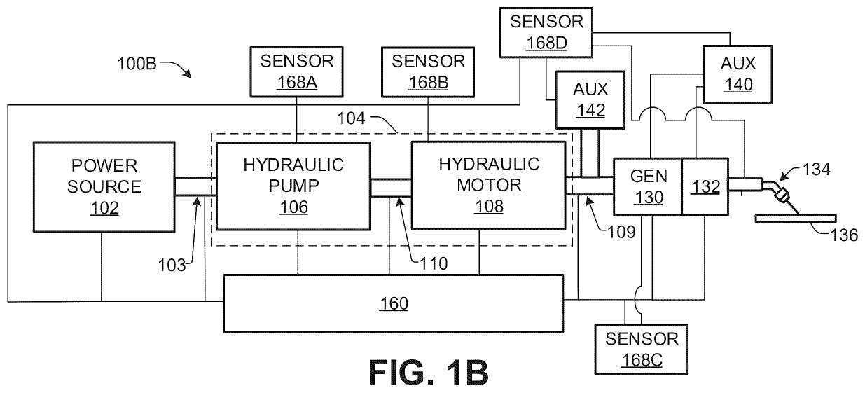

FIG. 1A is a block diagram of an exemplary first system 100A. The first system 100A is a hydraulically powered power system, and includes a hydraulic circuit 104, which receives power (e.g., mechanical and/or electrical power) from a power source 102 (e.g., an engine). Particularly, the power source 102 provides power to a pump 106 via a first linkage 103. The first linkage 103 may be a mechanical linkage, such as a power take-off (“PTO”), and/or an electrical linkage, such as an electrical cable. In some examples, the power source 102 may be directly coupled to the pump 106 without the first linkage 103.

The pump 106 is a hydraulic pump which generates hydraulic power by pumping a hydraulic fluid (e.g., hydraulic oil), thereby generating a flow of the hydraulic fluid through the hydraulic circuit 104. In examples, the pump 106 pumps the hydraulic fluid to and from a motor 108 via a hydraulic linkage 110. The motor 108 is a hydraulically driven motor, which converts hydraulic power of the flow of the hydraulic fluid (generated by the pump 106) to mechanical power. In the example of FIGS. 1A and 1B, the pump 106 is a fixed-displacement pump.

The motor 108 is mechanically coupled to a generator 130 via a second linkage 109 to provide the mechanical power to the generator 130, driving the generator 130 to generate electrical power (e.g., one or more alternating electrical currents). Accordingly, the generator 130 converts mechanical power generated by the motor 108 into electrical power (e.g., the one or more alternating electrical currents). The generator 130 thereby produces an electrical power output, which can be provided to power conversion circuitry 132 (e.g., an individual or combined generator and/or welding power supply).

In some examples, the generator 130 and/or the power conversion circuitry 132 provide an output (e.g., electrical power) to one or more first auxiliary devices 140. In examples, the one or more first auxiliary devices 140 are and/or include one or more of any, some, or all of lighting, a welding system, an air compressor, a charging system (e.g., a battery charging system), a hydraulic pump, a tool, a crane, a grinder, etc. In some examples, the generator 130 and/or the power conversion circuitry 132 provide power to only one of the first auxiliary devices 140. In some examples, the generator 130 and/or the power conversion circuitry 132 provide power to any plurality of the first auxiliary devices 140. In some examples, the generator 130 and/or the power conversion circuitry 132 provide power to none of the first auxiliary devices 140. In some examples, the first system 100A includes any, some, or all of the one or more first auxiliary devices 140. In some examples, the first system 100A includes none of the one or more first auxiliary devices 140.

In some examples, the power conversion circuitry 132 provides power for one or more tools 134. In examples, the one or more tools 134 may include any, some, or all of a welding tool (e.g., a welding torch, a wire feeder, and/or one or more other components of a welding system), a wrench, and/or another device. For example, the one or more tools 134 may include a welding torch, and the power conversion circuitry 132 may provide power to the welding torch to perform a welding and/or cutting operation on a workpiece 136. In some examples, the generator 130 and/or the power conversion circuitry 132 provide power to only one of the tools 134. In some examples, the generator 130 and/or the power conversion circuitry 132 provide power to any plurality of the tools 134. In some examples, the generator 130 and/or the power conversion circuitry 132 provide power to none of the tools 134. In some examples, the first system 100A includes any, some, or all of the one or more tools 134. In some examples, the first system 100A includes none of the one or more tools 134.

In some examples, the second linkage 109 is a mechanical linkage (e.g., a clutch, a transmission, a belt, a drive shaft, etc.). In some examples, the generator 130 is directly driven by the motor 108 (e.g., the second linkage 109 is a driveshaft directly coupling the motor 108 to the generator 130). In some examples, the generator 130 is indirectly driven by the motor 108, such as by being coupled by one or more linkages and/or one or more other intervening components and/or devices. In some examples, the second linkage 109 directly couples and/or integrates the generator 130 with the motor 108. For instance, the generator 130 and the motor 108 may be enclosed within a single housing or otherwise physically coupled.

Accordingly, in the first system 100A, the power source 102 powers the pump 106 (i.e., via mechanical and/or electrical power provided by the first linkage 103), the pump 106 powers the motor 108 (i.e., via hydraulic power provided by the hydraulic linkage 110), the motor 108 powers the generator 130 (i.e., via mechanical power provided by the second linkage 109), and the generator 130 powers the one or more tools 134 and/or the one or more first auxiliary devices 140 (i.e., via electrical power directly provided by the generator 130 and/or provided by the power conversion circuitry 132).

In examples, the generator 130 and/or the power conversion circuitry 132 may be configured to operate in one or more operational states. For example, the generator 130 and/or the power conversion circuitry 132 may be configured to operate in an operating mode, an off mode, and/or one or more other modes.

In examples, an off mode is a mode in which circuitry of the generator 130 and/or the power conversion circuitry 132 is not being controlled or operated to generate a power output or. In examples, an off mode is a mode in which circuitry of the generator 130 and/or the power conversion circuitry 132 is generating a power output lesser than a pre-determined threshold. In examples, an off mode of the generator 130 and/or the power conversion circuitry 132 is a mode wherein the generator 130 and/or the power conversion circuitry 132 is not in an operating mode.

In examples, an operating mode is a mode in which circuitry of the generator 130 and/or the power conversion circuitry 132 is being controlled or operated to generate any power output. In examples, an operating mode is a mode in which circuitry of the generator 130 and/or the power conversion circuitry 132 is generating a power output greater than a pre-determined threshold. In some examples, an operating mode may include a plurality of operational states. In examples, an operating mode includes an active mode, wherein the generator 130 and/or the power conversion circuitry 132 is outputting electrical power to one or more of the tools 134 and/or one or more of the first auxiliary devices 140 while at least one of the tools 134 and/or at least one of the first auxiliary devices 140 is exerting a load demand (e.g., measured in watts, kg m/s, as a function of an operating speed (e.g., measured in revolutions per minute (“RPM”)) and/or as a function of a torque (e.g., measured in kg m), etc.) upon the generator 130 and/or the power conversion circuitry 132. In examples, an operating mode includes a standby mode, wherein the generator 130 and/or the power conversion circuitry 132 is outputting electrical power to one or more of the tools 134 and/or one or more of the first auxiliary devices 140 while at least one of the tools 134 and/or at least one of the first auxiliary devices 140 is not exerting a load demand upon the generator 130 and/or the power conversion circuitry 132 and/or is exerting an insubstantial load demand upon the generator 130 and/or the power conversion circuitry 132.

In some examples, a mode of the generator 130 is a function of an operating speed of the generator 130 and/or a function of an operating frequency of electrical power output by the generator 130 and/or the power conversion circuitry 132. In some examples, an operating mode of the generator 130 is a mode in which electrical power output by the generator 130 and/or the power conversion circuitry 132 has an operating frequency of greater than 0 Hz, greater than or equal to 5 Hz, greater than or equal to 10 Hz, greater than or equal to 20 Hz, or even greater than or equal to 35 Hz. In some examples, an operating mode of the generator 130 is a mode in which electrical power output by the generator 130 and/or the power conversion circuitry 132 has an operating frequency of less than or equal to 65 Hz and greater than or equal to 0 Hz, greater than or equal to 5 Hz, greater than or equal to 10 Hz, greater than or equal to 20 Hz, or even greater than or equal to 35 Hz. In some examples, an active mode of the generator 130 is a mode in which an electrical current output by the generator 130 and/or the power conversion circuitry 132 has an operating frequency greater than or equal to 45 Hz or greater than or equal to 55 Hz. In some examples, an active mode of the generator 130 is a mode in which electrical power output by the generator 130 and/or the power conversion circuitry 132 has an operating frequency less than or equal to 65 Hz and greater than or equal to 45 Hz or greater than or equal to 55 Hz. In some examples, a standby mode of the generator 130 is a mode in which electrical power output by the generator 130 and/or the power conversion circuitry 132 has an operating frequency greater than or equal to 35 Hz. In some examples, a standby mode of the generator 130 is a mode in which electrical power output by the generator 130 and/or the power conversion circuitry 132 has an operating frequency greater than or equal to 35 Hz and less than or equal to 45 Hz. In some examples, an off mode of the generator 130 is a mode in which electrical power output by the generator 130 and/or the power conversion circuitry 132 has on operating frequency of substantially 0 Hz, less than 5 Hz, less than 10 Hz, less than 20 Hz, or even less than 35 Hz. In some examples, an off mode of the generator 130 is a mode in which the generator 130 is not in an operating mode.

While, in the example of FIG. 1A, the first system 100A includes the power source 102, in other examples, the power source 102 may be external to the first system 100A. In some examples, the first system 100A is mounted to and/or otherwise incorporated with a vehicle, such as a work truck (not shown). In some examples, the vehicle can include the power source 102, such as the vehicle engine or a mounted engine directly connected to the pump 106, and/or to drive the first linkage 103 to drive the pump 106. In some examples, the pump 106 is incorporated with the power source 102. In some examples, the pump 106 and the power source 102 are enclosed within a common housing. In some examples, the pump 106 and/or the power source 102 are housed within the vehicle itself.

In some examples, the power conversion circuitry 132 is an electric welding-type power supply and/or is incorporated within an electric welding-type power supply, such that the power conversion circuitry 132 generates converted power which can be regulated to provide power to the one or more tools 134 (e.g., a welding torch) for arc welding and/or cutting. In some examples, the power conversion circuitry 132 additionally and/or alternatively regulates power provided to and/or power output of the one or more first auxiliary devices 140.

In some examples, the first system 100A is configured such that the generator 130, coupled to and driven by the motor 108, provides a power output for the power conversion circuitry 132 to convert the power output from the generator 130 to a synchronous AC power output. In some examples, the power conversion circuitry 132, which receives a variable AC input from the generator 130, is configured to generate the synchronous AC power output to any, some, or all of the one or more tools 134 and/or any, some, or all of the one or more first auxiliary devices 140.

In some examples, the regulated power output can be described as a synthetic auxiliary output, with the power delivered to any, some, or all of the one or more first auxiliary devices 140 and/or any, some, or all of the tools 134 being converted into power over a range of voltage and/or current output curves, over a range of values (e.g., 120V-240V, 15 A-500 A, at 50-60 Hz).

In some examples, the pump 106 has a range of operating pressures, which can be between approximately 2,500 and 4,500 pounds per square inch (PSI).

In disclosed examples, an engine of the power source 102 has a capacity up to 65 horsepower and/or up to 3,600 RPM. In some examples, an engine of the power source 102 has a capacity up to 25 horsepower and 2,500 RPM, although other power capacity engines are considered. In some examples, an engine of the power source 102 operates on four or fewer cylinders (e.g., a two-cylinder piston engine), although other engine types are considered.

FIG. 1B is a block diagram of an exemplary second system 100B. The second system 100B is a hydraulically powered power system and includes a number of similar components to that of the first system 100A, with the addition of one or more second auxiliary devices 142. In some examples, the motor 108 provides an output (e.g., mechanical power) to the one or more second auxiliary devices 142. Accordingly, the one or more second auxiliary devices 142 may exert a load demand on the second linkage 109 and/or the motor 108. In examples, a load demand exerted by the one or more second auxiliary devices 142 may be directly measured, e.g., as a force (measured in, e.g., kg m/s) or indirectly measured, e.g., as an effect on an operating speed (measured in, e.g., RPM) of the motor 108 and/or a torque (measured in, e.g., kg m) generated by the motor 108.

In examples, the one or more second auxiliary devices 142 are and/or include one or more of any, some, or all of lighting, a welding system and/or components thereof (e.g., a welding wire feeder and/or a welding torch), an air compressor, a charging system (e.g., a battery charging system), a hydraulic pump, a tool, a crane, a grinder, a wrench, etc. In some examples, the motor 108 provides power to only one of the second auxiliary devices 142. In some examples, the motor 108 provides power to any plurality of the second auxiliary devices 142. In some examples, the motor 108 provides power to none of the first auxiliary devices 140. In some examples, the second system 100B includes any, some, or all of the one or more second auxiliary devices 142. In some examples, the second system 100B includes none of the one or more second auxiliary devices 142. In some examples, the second system 100B includes the one or more second auxiliary devices 142 but not the generator 130.

In the example of FIG. 1B, the second linkage 109 additionally and/or alternatively provides mechanical power to the second auxiliary devices 142 from the motor 108. In examples, the generator 130 and/or the second auxiliary devices 142 are mechanically coupled to the second linkage 109. For example, the one or more second auxiliary devices 142 may include an air compressor, which is turned by the mechanical power output via the second linkage 109 from the motor 108. Although illustrated as a single linkage to drive multiple outputs, in some examples the motor 108 may provide power via multiple linkages for multiple direct and/or indirect connections with the generator 130 and/or one or more of the second auxiliary devices 142. In some examples, the systems 100A, 100B include any combination of none, one, or any plurality of the first auxiliary devices 140 and none, one, or any plurality of the second auxiliary devices 142.

In the examples of FIGS. 1A and 1B, the systems 100A, 100B include control circuitry 160. In examples, the control circuitry 160 is electrically coupled to (e.g., can send and/or receive electrical signals to and/or from) any, some, or all of the power source 102, the first linkage 103, the pump 106, the hydraulic linkage 110, the motor 108, the second linkage 109, the generator 130, the power conversion circuitry 132, one or more of the tools 134, one or more of the first auxiliary devices 140, and/or one or more of the second auxiliary devices 142, as a list of non-limiting examples.

In some disclosed examples, the control circuitry 160 monitors one or more operating characteristics of either or both of the systems 100A, 100B or the various components. In examples, the control circuitry 160 monitors any, some, or all of a power input to and/or power output from the pump 106, a power input to and/or power output from the motor 108 (e.g., input flow, operating speed, output torque, pressure, resistance, etc.), a power input to and/or power output from the generator 130 (e.g., operating frequency and/or volts and/or amperage of the electrical current), an operating speed of the generator 130, and/or a power input to, a power output from, and/or a (measured or desired) load demand of one or more of the first auxiliary devices 140 and/or one or more of the second auxiliary devices 142.

In some examples, the control circuitry 160 monitors one or more operating characteristics of the systems 100A, 100B via a sensor system 168. The sensor system 168 may include one or more sensors, and each of the one or more sensors of the sensor system 168 may monitor one or more components and/or operating characteristics of the systems 100A, 100B. Each of the one or more sensors of the sensor system 168 may produce one or more sensor signals, and each sensor signal may include one or more measured operating characteristics of one or more components of the systems 100A, 100B.

In examples, one or more first sensors 168A may measure operating characteristics of the pump 106, the first linkage 103, the hydraulic linkage 110, and/or a hydraulic fluid pumped by the pump 106 and within the hydraulic circuit 104. For example, the one or more first sensors 168A may measure any, some, or all of a flow rate of the hydraulic fluid (e.g., measured in cubic meters per second (“cms”), cubic feet per second (“cfs”), gallons per minute (“gpm”), etc.) pumped by the pump 106, a pressure within the pump 106 and/or the hydraulic linkage 110, a temperature, heat output, and/or oil weight of the hydraulic fluid within the pump 106 and/or the hydraulic linkage 110, and/or a power input to the pump 106 provided by the first linkage 103 (e.g., input torque, speed, voltage, amperage, etc.). In examples, the one or more first sensors 168A may comprise one or more of any, some, or all of a flowmeter, a thermometer, a pressure sensor, a weight sensor, a torque sensor, a tachometer, a voltmeter, a current sensor, an electromagnetic field (“EMF”) sensor, and/or one or more other sensors (e.g., one or more sensors elsewhere herein). In examples, the one or more first sensors 168A may provide one or more first sensor signals comprising one or more measured operating characteristics (e.g., a measured flow rate, a measured pressure, etc.) to the control circuitry 160.

In examples, one or more second sensors 168B may measure operating characteristics of the motor 108, the hydraulic linkage 110, the second linkage 109, and/or a hydraulic fluid pumped within the hydraulic linkage 110 and through the motor 108. For example, the one or more second sensors 168B may measure any, some, or all of a flow rate of the hydraulic fluid through the hydraulic linkage 110 and/or through the motor 108, a pressure within the motor 108 and/or the hydraulic linkage 110, a temperature, heat output, and/or oil weight of the hydraulic fluid within the motor 108 and/or the hydraulic linkage 110, an operating speed (e.g., in RPM) of the motor 108 and/or a torque generated by the motor 108, and/or a power output generated by the motor 108 and provided to the second linkage 109 (e.g., output torque, operating speed, etc.). In examples, the one or more second sensors 168B may comprise one or more of any, some, or all of a flowmeter, a thermometer, a pressure sensor, a weight sensor, a torque sensor, a tachometer, a voltmeter, a photoelectric speed sensor, a Hall effect sensor, an application specific integrated circuit (“ASIC”) sensor, a Hall ASIC sensor, a magnetic pickup sensor, and/or one or more other sensors (e.g., one or more sensors described elsewhere herein). In examples, the one or more second sensors 168B may provide one or more second sensor signals comprising one or more measured operating characteristics (e.g., a measured flow rate, a measured pressure, etc.) to the control circuitry 160.

In examples, one or more third sensors 168C may measure operating characteristics of the generator 130, the power conversion circuitry 132, the second linkage 109, and/or electrical power output by the generator 130 and/or the power conversion circuitry 132. For example, the one or more third sensors 168C may measure any, some, or all of a voltage and/or an amperage of electrical power output by the generator 130 and/or the power conversion circuitry 132, an operating frequency (e.g., in Hz) of electrical power output by the generator 130 and/or the power conversion circuitry 132, an operational state (e.g., an operating mode, an off mode, an active mode, a standby mode, etc.) of the generator 130 and/or the power conversion circuitry 132, an operating speed (e.g., in RPM) of the generator 130, and/or a power input received by the generator 130 from the second linkage 109 (e.g., input torque, operating speed, etc.). In examples, the one or more third sensors 168C may comprise one or more of any, some, or all of a voltmeter, a current sensor, a frequency sensor, an EMF sensor, a torque sensor, a tachometer, a pressure sensor, a thermometer, a photoelectric speed sensor, a Hall effect sensor, an ASIC sensor, a Hall ASIC sensor, a magnetic pickup sensor, and/or one or more other sensors (e.g., one or more sensors described elsewhere herein). In examples, the control circuitry 160 may determine a measured operating speed of the motor 108 and/or a measured torque generated by the motor 108 using a sensor signal from one or more of the third sensors 168C. In some such examples, the control circuitry 160 determines a measured operating speed of the motor 108 and/or a measured torque generated by the motor 108 using a measured operating speed of electrical power output by the generator 130 and/or the power conversion circuitry 132, as measured by one or more of the third sensors 168C. In examples, the one or more third sensors 168C may provide one or more third sensor signals comprising one or more measured operating characteristics (e.g., a measured operating speed) to the control circuitry 160.

In examples, one or more fourth sensors 168D may measure operating characteristics of one or more of the tools 134, one or more of the first auxiliary devices 140, and/or one or more of the second auxiliary devices 142. In examples, the one or more fourth sensors 168D may measure any, some, or all of a voltage and/or an amperage of an electrical current input received by one or more of the tools 134 from the generator 130 and/or the power conversion circuitry 132, a load demand of one or more of the tools 134, air pressure of one or more of the tools 134 (e.g., air pressure of one or more compressors), air flow of one or more of the tools 134 (e.g., air flow of one or more compressors), and/or a desired load demand of one or more of the tools 134 (e.g., in volts or amps). In examples, the one or more fourth sensors 168D may measure any, some, or all of a voltage and/or an amperage of an electrical current input received by one or more of the first auxiliary devices 140 from the generator 130 and/or the power conversion circuitry 132, a power input received by one or more of the second auxiliary devices 142 from the second linkage 109 (e.g., input torque, operating speed, etc.), a load demand of one or more of the auxiliary devices 140, 142 (e.g., in volts or amps of the electrical current received by one or more of the first auxiliary devices 140 and/or in speed and/or torque of the mechanical power received by one or more of the second auxiliary devices 142), and/or a desired load demand of one or more of the auxiliary devices 140, 142 (e.g., in volts, amps, speed, and/or torque). In examples, the one or more fourth sensors 168D may comprise one or more of any, some, or all of a voltmeter, a current sensor, an EMF sensor, a torque sensor, a tachometer, a pressure sensor, an air pressure sensor, an air flow sensor, and/or one or more other sensors (e.g., one or more sensors described elsewhere herein). In examples, the one or more fourth sensors 168D may provide one or more fourth sensor signals comprising one or more measured operating characteristics (e.g., a measured load demand) to the control circuitry 160.

In examples, the systems 100A, 100B may include one, none, and/or any plurality of any, some, or all of the sensors 168A, 168B, 168C, 168D. In examples, the systems 100A, 100B may include one or more additional sensors to measure one or more additional operating characteristics of the systems 100A, 100B.

The control circuitry 160 controls either or both of the systems 100A, 100B and/or one or more components (electrically coupled to the control circuitry 160) of the systems 100A, 100B, e.g., by outputting a control signal to one or more of the components. Accordingly, the control circuitry 160 may control either or both of the systems 100A, 100B and/or one or more components thereof based on measured operating characteristics of the systems 100A, 100B and/or one or more components thereof. The control circuitry 160 may receive such measured operating characteristics via one or more sensor signals generated by one or more of the sensors 168A, 168B, 168C, 168D and/or via one or more other input signals and/or control signals. Accordingly, one or more signals may trigger an automatic response by the control circuitry 160 to control one or more components of the systems 100A, 100B. This response may include directly or indirectly adjusting an operating characteristic associated with one or more components of the systems 100A, 100B. In examples, control of either or both of the systems 100A, 100B and/or one or more components thereof can be regulated by the control circuitry 160. In examples, the control circuitry 160 can adjust (directly and/or indirectly) one or more operating characteristics of any, some, or all of the pump 106, the motor 108, one or more additional and/or alternative components of the hydraulic circuit 104, the generator 130, the power conversion circuitry 132, the one or more tools 134, the one or more first auxiliary devices 140, and/or the one or more second auxiliary devices 142. Furthermore, one or more of the linkages 103, 109, 110 may be controlled to completely or partially engage or disengage in response to the one or more operating characteristics. For example, the control circuitry 160 may directly or indirectly control an output of the motor 108 to the generator 130 and/or one or more of the second auxiliary devices 142, e.g., to improve mechanical and/or electrical generation of or within either or both of the systems 100A, 100B.

For example, the control circuitry 160 may receive a measured load demand of one of the first auxiliary devices 140 in a sensor signal generated by one of the fourth sensors 168D. In some such examples, based on the measured load demand (e.g., by determining that the measured load demand is increasing), the control circuitry 160 may directly adjust an operating characteristic of an output of either or both of the systems 100A, 100B, e.g., by controlling the power conversion circuitry 132 to increase an amperage of electrical power output from the power conversion circuitry 132 to the one of the first auxiliary devices 140. In some additional and/or alternative such examples, based on the measured load demand (e.g., by determining that the measured load demand has become zero), the control circuitry 160 may indirectly adjust an operating characteristic of an output of either or both of the systems 100A, 100B by controlling the first linkage 103 to disengage from the pump 106, thereby eliminating a power supply of the hydraulic circuit 104, which eliminates a power supply of the generator 130, which causes the generator 130 to cease generating electrical power.

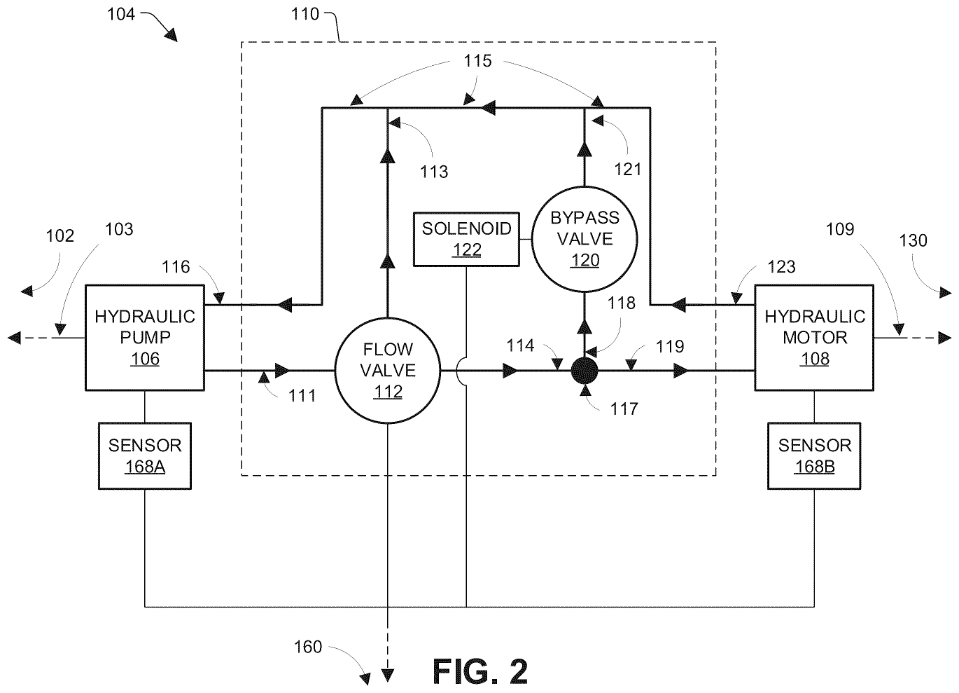

Referring to FIG. 2, an example of the hydraulic circuit 104 of FIGS. 1A-1B is more closely illustrated in a block diagram depicting components of the hydraulic linkage 110. The hydraulic circuit 104 provides (depending on a configuration of one or more components of the hydraulic linkage 110) one or more paths for a hydraulic fluid to flow to and from the pump 106. The hydraulic fluid is pumped out of the pump 106 through a pump outlet 111. The pump outlet 111 provides a path for hydraulic fluid from the pump 106 to a flow valve 112. Depending on a configuration of the flow valve 112, the flow valve 112 directs a flow of the hydraulic fluid to a flow valve fluid return outlet 113 or to a flow valve motor outlet 114.

In examples, the flow valve 112 occupies one of at least two states. In an off state, the flow valve 112 disables flow of the hydraulic fluid to the motor 108 by directing the flow of the hydraulic fluid through the flow valve fluid return outlet 113 and to a fluid return 115. The fluid return 115 leads to a pump inlet 116, and so, when the flow valve 112 is in the off state, the pump 106 can pump the hydraulic fluid only on a circuit defined by the pump 106, the pump outlet 111, the flow valve fluid return outlet 113, the fluid return 115, and the pump inlet 116. Accordingly, in examples, when the flow valve 112 is in the off state, none or substantially none of the hydraulic fluid is pumped through the motor 108. In an operating state, the flow valve 112 enables flow of the hydraulic fluid to the motor 108 by directing the flow of the hydraulic fluid through the flow valve motor outlet 114 and toward the motor 108. Accordingly, in examples, when the flow valve 112 is in the operating state, all or substantially all of the hydraulic fluid is directed into the flow valve motor outlet 114 and toward the motor 108.

In examples, the flow valve 112 is electrically coupled to the control circuitry 160, e.g., such that the control circuitry 160 can control a state of the flow valve 112. In some such examples, the one or more first sensors 168A includes a sensor which measures a state of the flow valve 112 (e.g., the off state or the operating state described above). In examples, the control circuitry 160 may control the flow valve 112 based on an operational state of the generator 130 and/or the power conversion circuitry 132. For example, the control circuitry 160 determines an operational state of the generator 130 (e.g., whether the generator 130 is in an operating mode or an off mode), e.g., based on a controlling of the generator 130 by the control circuitry 160 and/or by a sensor signal generated by one or more of the second sensors 168B. In some examples, upon determining that the generator 130 is in the off mode, the control circuitry 160 outputs a control signal to control the flow valve 112 to disable flow of a hydraulic fluid to the motor 108 by directing the flow of the hydraulic fluid to the flow valve fluid return outlet 113. In some examples, upon determining that the generator 130 is in the operating mode, the control circuitry 160 outputs a control signal to control the flow valve 112 to enable flow of a hydraulic fluid to the motor 108 by directing the flow of the hydraulic fluid to the flow valve motor outlet 114.

In the example of FIG. 2, the hydraulic linkage 110 includes only one flow valve. However, in other examples, the hydraulic linkage 110 does not include the flow valve 112 or includes any plurality of flow valves. In the example of FIG. 2, the flow valve 112 has only two outlets (i.e., the flow valve fluid return outlet 113 and the flow valve motor outlet 114). However, in other examples, the flow valve 112 has any plurality of outlets.

When the flow valve 112 is directing flow of a hydraulic fluid through the flow valve motor outlet 114 (i.e., to the motor 108), the hydraulic fluid flows through the flow valve motor outlet 114 and to a bypass junction 117. In the example of FIG. 2, the bypass junction 117 provides two outlets for the flow of the hydraulic fluid: a bypass valve inlet 118, and a motor inlet 119. The motor inlet 119 is an inlet to the motor 108, and so hydraulic fluid flowing through the motor inlet 119 will travel through the motor 108, thereby providing input power (i.e., hydraulic power) to the motor 108 for conversion into output power (e.g., mechanical power). The bypass valve inlet 118 leads to a bypass valve 120.

In examples, the bypass valve 120 is a hydraulic proportional bypass valve which can divert a portion of the hydraulic fluid (e.g., measured in cms, cfs, gpm, etc. from flowing through the motor inlet 119 by directing the portion of the hydraulic fluid from the bypass valve inlet 118, through a bypass valve outlet 121, and into the fluid return 115. In examples, a magnitude of the portion of the hydraulic fluid diverted by the bypass valve 120 is determined by a degree of openness of the bypass valve 120. For example, the bypass valve 120 may vary between a closed state and one or more open states. When in the closed state, the bypass valve 120 allows none or substantially none of the hydraulic fluid into the bypass valve outlet 121, such that all or substantially all of the hydraulic fluid pumped by pump 106 through the flow valve 112 passes through the motor 108. When in an open state, a degree of openness of the bypass valve 120 in the open state determines (in part) a flow rate of the hydraulic fluid through the bypass valve 120 and, thereby, the magnitude of the portion of the hydraulic fluid diverted from the motor inlet 119.

In examples, the bypass valve 120 may be controllably adjusted to occupy the closed state and/or one of a plurality of open states, wherein each open state of the plurality of open states is defined by a distinct degree of openness. Accordingly, the magnitude of the portion of the hydraulic fluid diverted by the bypass valve 120 may be variable between a minimum magnitude and a maximum magnitude. In examples, the minimum magnitude and the maximum magnitude of the portion of the hydraulic fluid diverted by the bypass valve 120 may be expressed in terms of a percentage of a flow through the flow valve motor outlet 114, wherein the minimum magnitude is 0% or substantially 0% of the flow through the flow valve motor outlet 114 (e.g., when the bypass valve 120 is in the closed state) and the maximum magnitude is a nonzero percentage (e.g., 60%, 50%, 40%, etc.) of the flow through the flow valve motor outlet 114 (e.g., when the bypass valve 120 is in an open state corresponding to a maximum degree of openness). In some examples, an amount of flow diverted through the bypass valve 120 has a non-linear relationship with a degree of openness of the bypass valve 120. For example, a first amount of flow diverted by the bypass valve 120 when the bypass valve 120 is 20% open may not be double a second amount of flow diverted by the bypass valve 120 when the bypass valve 120 is 40% open and may instead be another multiple of the first amount of flow. In examples, the minimum magnitude and the maximum magnitude of the portion of the hydraulic fluid diverted by the bypass valve 120, e.g., may be expressed in terms of cms, wherein the minimum magnitude is zero cms or substantially zero cms (e.g., when the bypass valve 120 is in the closed state) and a maximum amount of cms (e.g., when the bypass valve 120 is in an open state corresponding to a maximum degree of openness). In examples, the minimum magnitude and/or maximum magnitude may be a function of both the degree of openness of the bypass valve 120 and a pumping power of the pump 106 (e.g., as determined by the mechanical or electrical power provided to the pump 106 via the first linkage 103).

Accordingly, in examples, the bypass valve 120 can be controlled to cause a portion (of variable and/or adjustable magnitude) of the hydraulic fluid to bypass the motor 108 when pumped by the pump 106 and through the flow valve 112 to the flow valve motor outlet 114. In examples, the bypass valve 120 is electrically coupled to the control circuitry 160 such that the control circuitry 160 can control the degree of openness of the bypass valve 120. In some such examples, the bypass valve 120 includes a solenoid 122 which may adjust the degree of openness of the bypass valve 120 (e.g., by mechanically expanding and/or contracting to actuate the bypass valve 120) based on qualities of an electrical current (e.g., amplitude, frequency, etc.) provided to the solenoid 122 by the control circuitry 160, the generator 130, and/or the power conversion circuitry 132. For example, the control circuitry 160 may control the power conversion circuitry 132 to provide an electrical current to the solenoid 122 at a fixed pulse width modulation frequency and, to vary the degree of openness of the bypass valve 120, the control circuitry 160 controls the power conversion circuitry 132 to modify an amplitude of the electrical current. In examples, one or more of the first sensors 168A and/or one or more of the second sensors 168B may provide a feedback signal to the control circuitry 160 indicating a measured amperage, voltage, electrical power, and/or other aspect of an electrical current provided to the solenoid 122 and/or a measured effect of the solenoid 122 on the degree of openness of the bypass valve 120.

In examples, varying a magnitude of the portion of the hydraulic fluid diverted by the bypass valve 120 causes an operating speed of the motor 108 and/or a torque generated by the motor 108 to vary, thereby causing an operating speed of the generator 130 and/or an operating frequency of electrical power output by the generator 130 and/or the power conversion circuitry 132 to also vary. For example, increasing the magnitude of the portion of hydraulic fluid diverted by the bypass valve 120 may decrease an operating speed of the motor 108, and may thereby decrease an operating speed of the generator 130 and/or an operating frequency of electrical power output by the generator 130 and/or the power conversion circuitry 132. As another example, decreasing the magnitude of the portion of hydraulic fluid diverted by the bypass valve 120 may increase an operating speed of the motor 108, and may thereby increase an operating speed of the generator 130 and/or an operating frequency of electrical power output by the generator 130 and/or the power conversion circuitry 132.

Accordingly, the control circuitry 160 can (e.g., when the generator 130 is in the operating mode) control a degree of openness of the bypass valve 120 to adjust an operating characteristic of the motor 108 (e.g., an operating speed of the motor 108 and/or a torque generated by the motor 108) and/or an operating characteristic of the generator 130 (e.g., an operating frequency of electrical power output by the generator 130 and/or an operating speed of the generator 130). Further, the control circuitry 160 may control the degree of openness of the bypass valve 120 based on one or more measured operating characteristics of the motor 108 and/or of the generator 130 (e.g., a measured operating speed of the motor 108, a measured torque of the motor 108, a measured operating speed of the generator 130, and/or a measured operating frequency of electrical power output by the generator 130 and/or the power conversion circuitry 132), e.g., received in sensor signals generated by any, some, or all of the sensors 168A, 168B, 168C, 168D. In examples, the control circuitry 160 controls the degree of openness of the bypass valve 120 based on one or more measured operating characteristics of the motor 108 and/or of the generator 130 by comparing the one or more measured operating characteristics to one or more respective target operating characteristics. In some such examples, the control circuitry 160 compares the one or more measured operating characteristics to the one or more respective target operating characteristics and control the degree of openness of the bypass valve 120 based on a tolerance threshold of each of the one or more target operating characteristics. In some such examples, the control circuitry 160 controls the degree of openness of the bypass valve 120 to bring or keep each of the one or more operating characteristics within the respective tolerance threshold of the respective target operating characteristic.

For example, the control circuitry 160 may control the degree of openness of the bypass valve 120 based on a measured operating frequency of electrical power output by the generator 130 and/or the power conversion circuitry 132 (e.g., measured by one of the third sensors 168C). In some such examples, the control circuitry 160 compares the measured operating frequency to a target operating frequency. In some such examples, the control circuitry 160 controls the degree of openness of the bypass valve 120 based on a tolerance threshold of the target operating frequency to bring and/or keep the measured operating frequency within the tolerance threshold of the target operating frequency. In some such examples, the tolerance threshold of the target operating frequency is greater than or equal to 2% of the target operating frequency and less than or equal to 6% of the target operating frequency. In some examples, the target operating frequency is less than or equal to 65 Hz and greater than or equal to 35 Hz. In some examples, the target operating frequency is less than or equal to 65 Hz and greater than or equal to 45 Hz. In some examples, the target operating frequency is less than or equal to 45 Hz and greater than or equal to 35 Hz. In some examples, when the generator 130 is in the active mode, the target operating frequency is less than or equal to 65 Hz and greater than or equal to 45 Hz. In some examples, when the generator 130 is in the standby mode, the target operating frequency is less than or equal to 45 Hz and greater than or equal to 35 Hz.

As another additional and/or alternative example, the control circuitry 160 may control the degree of openness of the bypass valve 120 based on a measured operating speed of the generator 130 (e.g., measured by one of the third sensors 168C). In some such examples, the control circuitry 160 compares the measured operating speed to a target operating speed. In some such examples, the control circuitry 160 controls the degree of openness of the bypass valve 120 based on a tolerance threshold of the target operating speed to bring and/or keep the measured operating speed within the tolerance threshold of the target operating speed. In some such examples, the tolerance threshold of the target operating speed is greater than or equal to 2% of the target operating speed and less than or equal to 6% of the target operating speed.

As another additional and/or alternative example, the control circuitry 160 may control the degree of openness of the bypass valve 120 based on a measured operating speed and/or a measured torque of the motor 108. In some such examples, the control circuitry 160 compares the measured operating speed and/or the measured torque to a target operating speed and/or a target torque. In examples, the control circuitry 160 receives the measured operating speed and/or the measured torque in a sensor signal from one or more of the second sensors 168B. In examples, the control circuitry 160 determines the measured operating speed and/or the measured torque using a measured operating frequency of an electrical current generated by the generator 130 and/or the power conversion circuitry 132 received in a sensor signal from one or more of the third sensors 168C. In examples, the control circuitry 160 determines the measured operating speed and/or the measured torque using a measured operating speed of the generator 130 received in a sensor signal from one or more of the third sensors 168C. In some examples, the control circuitry 160 controls the degree of openness of the bypass valve 120 based on a tolerance threshold of the target operating speed and/or a tolerance threshold of the target torque to bring and/or keep the measured operating speed and/or the measured torque within the tolerance threshold of the target operating speed and/or target torque. In some examples, the tolerance threshold of the target operating speed is greater than or equal to 2% of the target operating speed and less than or equal to 6% of the target operating speed. In some examples, the tolerance threshold of the target torque is greater than or equal to 2% of the target torque and less than or equal to 6% of the target torque.

As another example, the control circuitry 160 may control the degree of openness of the bypass valve 120 based on a measured load demand and/or a desired load demand of any, some, or all of one or more of the tools 134, one or more of the first auxiliary devices 140, and/or one or more the second auxiliary devices 142. In some such examples, the control circuitry 160 compares the measured load demand and/or the desired load demand to a threshold load value. In examples, the control circuitry 160 receives the measured load demand and/or the desired load demand in a sensor signal from one or more of the fourth sensors 168D. In some examples, if the control circuitry 160 determines that the measured load demand and/or the desired load demand exceeds the threshold load value, the control circuitry 160 controls the degree of openness of the bypass valve 120 to maximize and/or otherwise increase an operating speed of the motor 108 and/or a torque generated by the motor 108. In some examples, if the control circuitry 160 determines that the measured load demand and/or the desired load demand is increasing, the control circuitry 160 controls the degree of openness of the bypass valve 120 to increase an operating speed of the motor 108 and/or a torque generated by the motor 108. In some examples, if the control circuitry 160 determines that the measured load demand and/or the desired load demand is decreasing, the control circuitry 160 controls the degree of openness of the bypass valve 120 to decrease an operating speed of the motor 108 and/or a torque generated by the motor 108.

In the example of FIG. 2, the bypass valve 120 is positioned between the bypass junction 117 and the fluid return 115. In other examples, the bypass valve 120 may be placed at another position within the hydraulic circuit 104, such as at the bypass junction 117 or between the bypass junction 117 and the motor 108. In the example of FIG. 2, the hydraulic linkage 110 includes only one bypass valve. However, in other examples, the hydraulic linkage 110 may include any plurality of bypass valves.

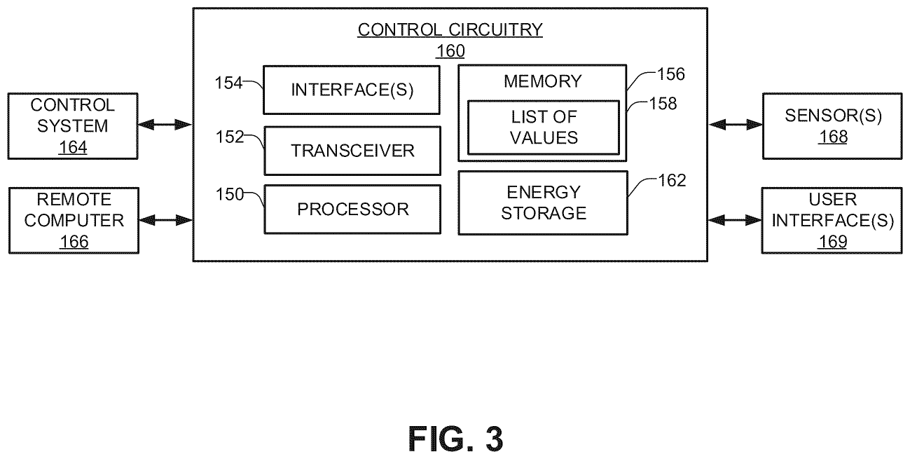

FIG. 3 is a block diagram of an example of the control circuitry 160, which can be configured as a microcontroller, or to include a processor 150, to perform as a programmable logic circuit, a system-on-chip, a programmable logic device, and/or any other type of logic circuit. The control circuitry 160 can be included in one or more components of the systems 100A, 100B (e.g., the power source 102, the generator 130, the power conversion circuitry 132, the one or more tools 134, etc.), and/or be implemented as the remote computer 166 provided in FIG. 3 and/or as another control device.

In some examples, the control circuitry 160 can include a transceiver 152 to communicate with one or more of the power source 102, the pump 106, the motor 108, the generator 130, the power conversion circuitry 132, one or more of the tools 134, one or more of the first auxiliary devices 140, one or more of the second auxiliary devices 142, one or more of the linkages 103, 109, 110, the bypass valve 120, the solenoid 122, and/or any, some, or all of the sensors 168A, 168B, 168C, 168D. One or more interfaces 154 can be included with or connected to the control circuitry 160, e.g., to provide a communications link with any, some, or all of the sensors 168A, 168B, 168C, 168D, a control system 164 (e.g., of the power source 102, the generator 130, the power conversion circuitry 132, one or more of the tools 134, one or more of the first auxiliary devices 140, one or more of the second auxiliary devices 142, one or more of the linkages 103, 109, 110, the bypass valve 120, the solenoid 122, etc.), and/or a remote computer 166 (e.g., a remote control, a laptop, smart phone, etc.).

In some examples, the control circuitry 160 includes a memory storage device 156, and/or an energy storage device 162. For example, information related to operating characteristics, pressure measurements, power trends, welding processes, etc., can be stored in a list of values 158, e.g., as a chart, a library, etc., within the memory storage device 156. In examples, target operating characteristics (e.g., a target operating frequency, a target operating speed, a target torque, etc.) are stored in the list of values 158. In examples, tolerance thresholds of target operating characteristics (e.g., a target operating frequency, a target operating speed, a target torque, etc.) are stored in the list of values 158.

In some examples, either or both of the systems 100A, 100B can include one or more user interfaces 169 (e.g., a switch, a computer input device, etc.) to provide options for an operator to control the systems 100A, 100B and/or one or more components thereof. In examples, the control circuitry 160 receives one or more target operating characteristics in an input signal generated by the one or more user interfaces 169 (e.g., as selected and/or input by a user of the one or more user interfaces 169). In examples, the control circuitry 160 receives one or more tolerance thresholds of one or more target operating characteristics in an input signal generated by the one or more user interfaces 169 (e.g., as selected and/or input by a user of the one or more user interfaces 169).

Additionally or alternatively, one or more component may be in direct communication with another component, for example, one or more of the various system components (e.g., the control circuitry 160) can be directly linked to any one or more of the other components (e.g., the generator 130, the power conversion circuitry 132, one or more of the tools 134, one or more of the first auxiliary devices 140, one or more of the second auxiliary devices 142, one or more of the linkages 103, 109, 110, the bypass valve 120, the solenoid 122, any, some, or all of the sensors 168A, 168B, 168C, 168D, etc.) to facilitate communication.

Any of the example sensors 168A, 168B, 168C, 168D may be a temperature sensor configured to measure a temperature of the hydraulic fluid. The control circuitry 160 may prevent operation of the hydraulic motor 108 while the measured temperature of the hydraulic fluid is less than a threshold temperature. For example, the control circuitry 160 may control the flow valve 112 and/or the bypass valve 120 to divert fluid away from the hydraulic motor 108 while the measured temperature of the hydraulic fluid is less than the threshold temperature, which prevents hydraulic flow from operating the hydraulic motor 108. Requiring the hydraulic fluid to be at least the threshold temperature helps protect the hydraulic motor 108 and related hydraulic components and allows the power source 102 to operate with reduced power to the hydraulic pump (e.g., fewer engine RPMs) while the hydraulic fluid is warming up.

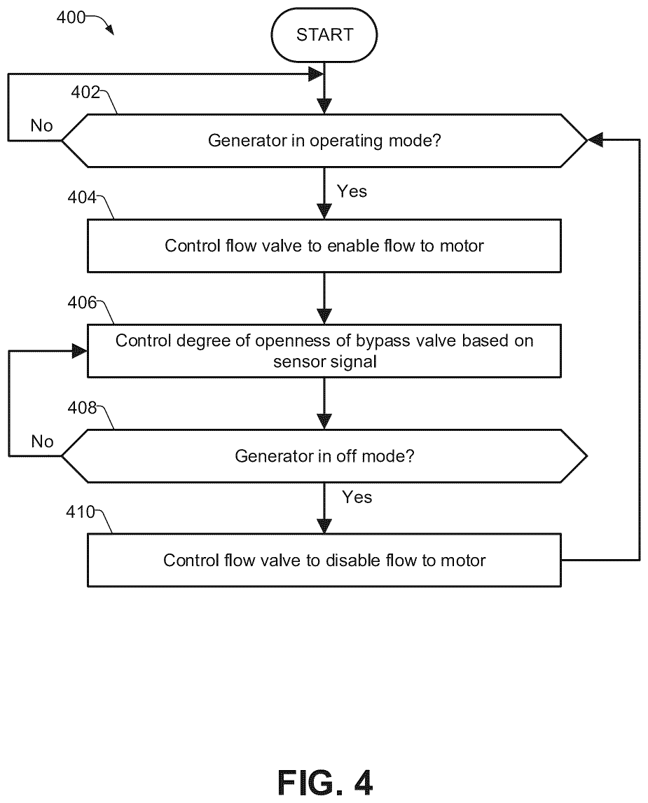

FIG. 4 is a flowchart illustrating an example method 400 of operating a hydraulically powered power system (e.g., either or both of the systems 100A, 100B). The method 400 may be implemented by control circuitry (e.g., the control circuitry 160) by executing machine-readable instructions, e.g., stored on a non-transitory machine-readable storage device (e.g., the memory storage device 156). In describing the method 400, reference will be made to the examples of FIGS. 1A-3. However, the method 400 may be used with other examples, such as alternative examples described elsewhere herein.

At a block 402 of the method 400, the control circuitry 160 determines whether the generator 130 is in an operating mode or an off mode. In examples, upon determining that the generator 130 is in the operating mode, the control circuitry 160 may further determine whether the generator 130 is in an active mode or a standby mode. In examples, the control circuitry 160 determines an operational state of the generator 130 using a sensor signal generated by one or more of the third sensors 168C. In some examples, the control circuitry 160 determines an operational state of the generator 130 based on a measured operating speed of the generator 130 (e.g., measured by one or more of the third sensors 168C) and/or a measured operating frequency of an electrical power output by the generator 130 and/or the power conversion circuitry 132 (e.g., measured by one or more of the third sensors 168C). If the control circuitry 160 determines that the generator 130 is not in the operating mode, the control circuitry 160 repeats the step of the block 402.

Upon determining that the generator 130 is in the operating mode, the control circuitry 160 continues to a step of a block 404 of the method 400. At the block 404, the control circuitry 160 controls the flow valve 112 to enable flow to the motor 108, e.g., by directing a flow of a hydraulic fluid through the flow valve motor outlet 114 and toward the motor 108.

At a block 406 of the method 400, the control circuitry 160 controls a degree of openness of the bypass valve 120 based on a sensor signal. In examples, the control circuitry 160 controls the degree of openness of the bypass valve 120 based on any, some, or all of a measured operating frequency of an electrical current generated by the generator 130 and/or the power conversion circuitry 132 (e.g., as measured by one or more of the third sensors 168C), a measured operating speed of the generator 130 (e.g., as measured by one or more of the third sensors 168C), a measured operating speed of the motor 108 (e.g., as measured by one or more of the second sensors 168B and/or as determined using the measured operating frequency), a measured torque of the motor 108 (e.g., as measured by one or more of the second sensors 168B and/or as determined using the measured operating frequency), and/or a measured load of one or more of any, some, or all of the tools 134, the first auxiliary devices 140, and/or the second auxiliary devices 142.

At a block 408 of the method 400, the control circuitry 160 determines whether the generator 130 has entered an off mode. In examples, the control circuitry 160 determines an operational state of the generator 130 using a sensor signal generated by one or more of the third sensors 168C. In some examples, the control circuitry 160 determines an operational state of the generator 130 based on a measured operating speed of the generator 130 and/or a measured operating frequency of an electrical power output by the generator 130. In examples, upon determining that the generator 130 is not in the off mode, the control circuitry 160 repeats the step of the block 406. In some such examples, the control circuitry 160 thereby constantly monitors one or more measured operating characteristics of the systems 100A, 100B and adjusts the degree of openness of the bypass valve 120 accordingly until the generator 130 is detected to be in the off mode.

Upon determining that the generator 130 is in the off mode, the control circuitry 160, the control circuitry 160 continues to a step of a block 410 of the method 400. At the block 410, the control circuitry 160 controls the flow valve 112 to disable flow to the motor 108, e.g., by directing the flow of hydraulic fluid through the flow valve fluid return outlet 113 and into the fluid return 115. Accordingly, the motor 108 ceases receiving hydraulic power and, therefore, ceases providing mechanical power to the generator 130, thereby causing the generator 130 and/or the power conversion circuitry 132 to cease generating an electrical current. Upon completing the step of the block 410, the control circuitry 160 returns to the step of the block 402.

While the present method, apparatus, and/or system has been described with reference to certain implementations, it will be understood by those skilled in the art that various changes, modifications, and variations may be made to the present disclosure and equivalents may be substituted without departing from the scope of the present disclosure. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A hydraulically powered power system comprising:
a hydraulic circuit comprising:
a hydraulically driven motor configured to convert hydraulic power to mechanical power,
a flow valve configured to enable or disable flow of hydraulic fluid to the hydraulically driven motor, and
a hydraulic proportional bypass valve configured to divert a portion of the hydraulic fluid from an inlet to the hydraulically driven motor to a fluid return based on a degree of openness of the hydraulic proportional bypass valve;
a generator configured to convert the mechanical power from the hydraulically driven motor to electrical power having an operating frequency;
a first sensor configured to measure the operating frequency of the electrical power and generate a first sensor signal comprising a measured operating frequency; and
control circuitry configured to:
determine whether the generator is in an operating mode or an off mode;
when the generator is in the operating mode, output a first control signal to control the flow valve to direct the flow of the hydraulic fluid to the hydraulically driven motor and output a second control signal to control the degree of openness of the hydraulic proportional bypass valve based on the measured operating frequency, and
when the generator is in the off mode, output the first control signal to control the flow valve to direct the flow of the hydraulic fluid to the fluid return.

2. The hydraulically powered power system of claim 1, wherein the control circuitry is further configured to:
control the hydraulic proportional bypass valve to divert more fluid to decrease the operating frequency; and
control the hydraulic proportional bypass valve to divert less fluid to increase the operating frequency.

3. The hydraulically powered power system of claim 1, wherein the controlling of the degree of openness of the hydraulic proportional bypass valve is based on comparing the measured operating frequency to a target operating frequency.

4. The hydraulically powered power system of claim 3, wherein the controlling of the degree of openness of the hydraulic proportional bypass valve is further based on a tolerance threshold of the target operating frequency.

5. The hydraulically powered power system of claim 4, wherein the tolerance threshold is less than or equal to 6% of the target operating frequency and greater than or equal to 2% of the target operating frequency.

6. The hydraulically powered power system of claim 3, further comprising a user interface electrically coupled to the control circuitry and configured to receive the target operating frequency and generate an input signal comprising the target operating frequency.

7. The hydraulically powered power system of claim 3, wherein the target operating frequency is less than or equal to 65 hertz and greater than or equal to 35 hertz.

8. The hydraulically powered power system of claim 1, further comprising an auxiliary device and a second sensor configured to measure a load demand of the auxiliary device and generate a second sensor signal comprising a measured load demand, wherein the controlling of the degree of openness of the hydraulic proportional bypass valve is further based on the measured load demand.

9. The hydraulically powered power system of claim 8, wherein the controlling of the degree of openness of the hydraulic proportional bypass valve is further based on comparing the measured load demand to a threshold load value.

10. The hydraulically powered power system of claim 1, wherein the control circuitry is further configured to control an operating speed of the hydraulically driven motor by controlling a flow rate of the hydraulic fluid at the inlet to the hydraulically driven motor.

11. The hydraulically powered power system of claim 10, wherein the control circuitry is further configured to:
determine a measured operating speed of the hydraulically driven motor based on the measured operating frequency; and
when the generator is in the operating mode, output the second control signal to control the degree of openness of the hydraulic proportional bypass valve based on the measured operating speed.

12. The hydraulically powered power system of claim 11, wherein the controlling of the operating speed of the hydraulically driven motor is further based on comparing the measured operating speed to a target operating speed.

13. The hydraulically powered power system of claim 12, wherein the controlling of the degree of openness of the hydraulic proportional bypass valve is further based on a tolerance threshold of the target operating speed.

14. The hydraulically powered power system of claim 13, wherein the tolerance threshold is less than or equal to 6% of the target operating speed and greater than or equal to 2% of the target operating speed.

15. The hydraulically powered power system of claim 13, further comprising a user interface electrically coupled to the control circuitry and configured to receive the tolerance threshold and generate an input signal comprising the tolerance threshold.

16. The hydraulically powered power system of claim 10, further comprising a second sensor configured to measure the operating speed of the hydraulically driven motor and generate a second sensor signal comprising a measured operating speed of the hydraulically driven motor, wherein the control circuitry is further configured to, when the generator is in the operating mode, output the second control signal to control the degree of openness of the hydraulic proportional bypass valve based on the measured operating speed of the hydraulically driven motor.

17. The hydraulically powered power system of claim 1, wherein the operating mode comprises an active mode, wherein the control circuitry is further configured to:
when the generator is in the operating mode, determine whether the generator is in the active mode; and
when the generator is in the active mode, control the degree of openness of the hydraulic proportional bypass valve based on comparing the measured operating frequency to a target operating frequency, wherein the target operating frequency is less than or equal to 65 hertz and greater than or equal to 45 hertz.

18. The hydraulically powered power system of claim 1, wherein the operating mode comprises a standby mode, wherein the control circuitry is further configured to:
when the generator is in the operating mode, determine whether the generator is in the standby mode; and
when the generator is in the standby mode, control the degree of openness of the hydraulic proportional bypass valve based on comparing the measured operating frequency to a target operating frequency, wherein the target operating frequency is less than or equal to 45 hertz and greater than or equal to 35 hertz.

19. The hydraulically powered power system of claim 1, wherein:
the hydraulic proportional bypass valve comprises a solenoid; and
the control circuitry is further configured to control the hydraulic proportional bypass valve by controlling the solenoid to adjust the degree of openness.

20. A hydraulically powered power system comprising:
a hydraulic circuit comprising:
a hydraulically driven motor configured to convert hydraulic power to mechanical power,
a flow valve configured to enable or disable flow of hydraulic fluid to the hydraulically driven motor, and
a hydraulic proportional bypass valve configured to divert a portion of the hydraulic fluid from an inlet to the hydraulically driven motor to a fluid return based on a degree of openness of the hydraulic proportional bypass valve;
a generator configured to convert the mechanical power from the hydraulically driven motor to electrical power;
a first sensor configured to measure an operating speed of the generator and generate a first sensor signal comprising a measured operating speed of the generator; and
control circuitry configured to:
determine whether the generator is in an operating mode or an off mode;
when the generator is in the operating mode, output a first control signal to control the flow valve to direct the flow of the hydraulic fluid to the hydraulically driven motor and output a second control signal to control the degree of openness of the hydraulic proportional bypass valve based on the measured operating speed of the generator, and
when the generator is in the off mode, output the first control signal to control the flow valve to direct the flow of the hydraulic fluid to the fluid return.
